(19) United States
(12) Patent Application Publication
(10) Pub. No.: US 2010/0205611 A1
(43) Pub. Date: Aug. 12, 2010

(54) SYSTEM AND METHOD FOR PARALLEL STREAM PROCESSING

(75) Inventors: Alan Shelton Wagner, Richmond (CA); Camilo Ellis Rostoker, Vancouver (CA)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Scalable Analytics, Inc., Vancouver (CA)

(21) Appl. No.: 12/608,501

(22) Filed: Oct. 29, 2009

Related U.S. Application Data
(60) Provisional application No. 61/152,190, filed on Feb. 12, 2009.

(51) Int. Cl. G06F 3/00; G06F 9/46

(52) U.S. Cl. 719/313

(57) ABSTRACT

We describe the design of a lightweight library using MPI to support stream-processing on acyclic process structures. The design can be used to connect together arbitrary modules where each module can be its own parallel MPI program. We make extensive use of MPI groups and communicators to increase the flexibility of the library, and to make the library easier and safer to use. The notion of a communication context in MPI ensures that libraries do not conflict where a message from one library is mistakenly received by another. The library is not required to be part of any larger workflow environment and is compatible with existing MPI execution environments. The library is part of MarketMiner, a system for executing financial workflows.

### RELATED APPLICATION

This application claims priority to U.S. provisional patent application No. 61/152,190, filed Feb. 12, 2009. All patents, patent applications, and other publications cited in this application are incorporated by reference in the entirety for all purposes.

### FIELD

The subject matter disclosed generally relates to a system and method for parallel stream processing.

### BACKGROUND

The following background references are noted:
[1] S. Yamagiwa and L. Sousa, “Design and implementation of a streambased distributed computing platform using graphics processing units,” in Conf. Computing Frontiers, U. Banerjee, J. Moreira, M. Dubois, and P. Stenstrom, Eds. ACM, 2007, pp. 197-204.
[2] M.P.I. Forum, “MPI: A Message-Passing Interface standard,” Department of Computer Science, University of Tennessee, Tech. Rep. UT-CS-94-230, 1994. [Online]. Available: citeseer.nj.nec.com/article/forum94 mpi.html
[3] W. Gropp, “Learning from the success of MPI,” in HiPC '01: Proceedings of the 8th International Conference on High Performance Computing. London, UK: Springer-Verlag, 2001, pp. 81-94.
[4] W. Gropp and E. Lusk, “Goals guiding design: PVM and MPI,” Cluster Computing, 2002. Proceedings. 2002 IEEE International Conference on, pp. 257-265, 2002.
[5] C. Rostoker, A. Wagner, and H. H. Hoos, “A parallel workflow for realtime correlation and clustering of high-frequency stock market data,” in IPDPS. IEEE, 2007, pp. 1-10.
[6] “MPICH2 homepage.” [Online]. Available: http://www-unix.mcs.anl. gov/mpi/mpich/
[7] “Open MPI homepage.” [Online]. Available: http://www.open-mpi.org/
[8] D. Thain, T. Tannenbaum, and M. Livny, “Distributed computing in practice: the Condor experience.” Concurrency—Practice and Experience, vol. 17, no. 2-4, pp. 323-356, 2005.
[9] T. Oinn, M. Greenwood, M. Addis, M. N. Alpdemir, J. Ferris, K. Glover, C. Goble, A. Goderis, D. Hull, D. Marvin, P. Li, P. Lord, M. R. Pocock, M. Senger, R. Stevens, A. Wipat, and C. Wroe, “Taverna: lessons in creating a workflow environment for the life sciences: Research articles,” Concurr. Comput.: Pract. Exper., vol. 18, no. 10, pp. 1067-1100, 2006.
[10] “Streambase,” 2007. [Online]. Available: www.streambase.com
[11] N. T. Karonis, B. Toonen, and I. Foster, “MPICH-G2: a grid-enabled implementation of the Message Passing Interface,” J. Parallel Distrib. Comput., vol. 63, no. 5, pp. 551-563, 2003.
[12] O. Loques, J. Leite, and E. V. C. E., “P-RIO: A modular parallel programming environment,” IEEE Concurrency, vol. 6, no. 1, pp. 47-57, 1998.
[13] M. Isard, M. Budiu, Y. Yu, A. Birrell, and D. Fetterly, “Dryad: distributed data-parallel programs from sequential building blocks,” in EuroSys, P. Ferreira, T. R. Gross, and L. Veiga, Eds. ACM, 2007, pp. 59-72.
[14] J. M. Squyres and A. L. Director, “MPI: Extensions and applications,” Notre Dame, Tech. Rep., 1996.
[15] “Common component architecture,” 2008. [Online]. Available: www.cca-forum.org
[16] B. A. Allan, R. C. Armstrong, A. P. Wolfe, J. Ray, D. E. Bernholdt, an J. A. Kohl, “The CCA core specification in a distributed memory SPMD framework,” Concurrency and Computation: Practice and Experience, vol. 14, no. 5, pp. 323-345, 2002.
[17] M. R. Garey and D. S. Johnson, Computers and intractability: a guide to the theory of NP-completeness. W. H. Freeman, 1979.
[18] E. G. Boman, U. Catalyurek, A. H. Gebremedhin, and F. Manne, “A scalable parallel graph coloring algorithm for distributed memory computers,” in Proceedings of Euro-Par 2005 Parallel Processing. Springer-Verlag, 2005, pp. 241-251.
[19] F. Hoffman, “Communicators & groups, part 2,” Linux Magazine, pp. 46-43, 48-51, July 2003.

Stream-processing constitutes an important class of parallel applications that are widely used in all types of engineering systems [1]. The basic structure underlying stream-processing is an acyclically connected collection of components. Although there are many technologies that can be used as the “glue” to connect together these components, one such approach is to use the Message Passing Interface (MPI) library [2].

P-RIO [12], defines connections with inports and outports. P-RIO was implemented in PVM and there is no MPI implementation that takes advantage of MPI's mechanisms for the safe use of libraries. There are also systems like Dryad [13], which describes a rich interconnection system between modules, but is based on threads and not MPI. With regards to MPI, there is the work by Squyres [14], who describes an MPI library using the concept of a port.

The notion of ports also appears in the Common Component Architecture (CCA) [15], a standard for component-based architectures for High Performance Computing. The CCA compliant CAFFEINE framework [16] is restricted to the composition of SPMD modules and not for stream-based computing.

With the use of suitable routines, MPI can be used to create libraries which hide the non-essential complexities of maintaining the underlying structure while providing a high-level abstract interface to the user [3, 4].

### SUMMARY

We disclose a system which may comprise a library to support stream-processing, and in embodiments the system may be MPI based. The library may be used in the implementation of MarketMiner [5] a real-time stream-processing system targeted towards financial engineering workflows. In embodiments the system may comprise a number of modules and the modules of the system themselves can be highly parallel. In embodiments the subject matter may use MPI inter and intra communicators to provide a messaging environment that reduces the possibilities of incorrect messaging.

In a first embodiment, there is disclosed a computer implemented system for parallel processing which may include at least one process group which, during execution of the parallel process, may include: (a) a first digital data stream generated by a first process; (b) a second digital data stream generated by a second process; and, (c) a third process for controllably receiving the first and second data streams and in response thereto generating a third digital data stream. The first, second and third processes may be defined by a common unique communication context associated with the at least one group.

In alternative embodiments; the system may be represented by a conflict graph. Each node in the graph may be tagged to avoid deadlock in the system. The system may further comprise a plurality of the process groups, and each group may have a communication context distinct from the other groups; and a plurality of the first processes each having an associated first context. The third process may use the first context to distinguish between individual ones of the first processes. The system may comprise a display for displaying the third data stream in real time. The first and second processes may be performed periodically. The periods may be less thirty seconds. The context may be generated probabilistically.

In another embodiment, there is disclosed a computer implemented method for parallel processing. The method may comprise: providing a process group which during execution of the parallel process may comprise: (a) a first digital data stream generated by a first process; (b) a second digital data stream generated by a second process; (c) a third process for controllably receiving the first and second data streams and in response thereto generating a third digital data stream; and defining the first, second and third processes by a common unique communication context associated with the at least one group.

Features and advantages of the subject matter hereof will become more apparent in light of the following detailed description of selected embodiments, as illustrated in the accompanying figures. As will be realized, the subject matter disclosed is capable of modifications in various respects. Accordingly, the drawings and the description are to be regarded as illustrative in nature, and not as restrictive.

### BRIEF DESCRIPTION OF THE DRAWINGS

FIG. 1 is a Financial workflow with modules linked together using MPI-based middleware.

FIG. 2 is Eight possibilities for the inter communicator structure between groups.

FIG. 3 is a MPICH config file for Prime Number Sieve Pipeline, one process per stage.

FIG. 4 is a Main boilerplate needed to execute MPI program inside a workflow (library routines are shown in bold).

FIG. 5 is a Main part of program with two simple protocol adapters.

FIG. 6 is a topological ordering of the workflow.

FIG. 7 is an example of a proper labeling needed for creating inter-communicators.

FIG. 8 is a Two phase algorithm for creating inter-communicators.

FIG. 9 is an Example of a proper labeling needed for creating intra-communicators (Phase I) and inter-communicators (Phase II).

FIG. 10 is a three coloring of the conflict graph associated with FIG. 7.

FIG. 11 shows components of an exemplary operating environment for implementing embodiments.

FIG. 12 shows an exemplary computer system for implementing embodiments.

### DETAILED DESCRIPTION OF EMBODIMENTS

In this disclosure term “or” is generally employed in its sense including “and/or” unless the content clearly dictates otherwise.

In this disclosure, unless otherwise indicated, all numbers expressing quantities or ingredients, measurement of properties and so forth used in the specification and claims are to be understood as being modified in all instances by the term “about”. Accordingly, unless indicated to the contrary or necessary in light of the context, the numerical parameters set forth in the disclosure are approximations that can vary depending upon the desired properties sought to be obtained by those skilled in the art utilizing the teachings of the present disclosure and in light of the inaccuracies of measurement and quantification. Without limiting the application of the doctrine of equivalents to the scope of the claims, each numerical parameter should at least be construed in light of the number of reported significant digits and by applying ordinary rounding techniques. Not withstanding that the numerical ranges and parameters setting forth the broad scope of the disclosure are approximations, their numerical values set forth in the specific examples are understood broadly only to the extent that this is consistent with the validity of the disclosure and the distinction of the subject matter disclosed and claimed from the prior art.

In this disclosure the term “context” means and includes any identifiers or labels that may be associable or linkable with output or leader from a process to thereby identify its process of origin, or to permit it to be distinguished from the outputs or leaders of other processes. In embodiments a context may comprise a number or other distinguishing element associated with a data element, data stream, process or the like. In embodiments a context may be generated or assigned in a variety of ways including by suitable algorithms and by probabilistic methods, as well as by a range of alternative methods all of which will be readily understood and implemented by those skilled in the art.

in this disclosure the term “process” means and includes any one or more operations, threads of operations, analytical routines, modules, or other processes. A process may be an individual process or may comprise a plurality of constituent processes and in embodiments these may be interconnected to perform one or more collective functions. In the latter context it will be understood that the term “process” therefore includes a “group” as defined herein.

In this disclosure the term “group” means a group of processes, any of which may themselves be or include groups.

In this disclosure the term “system” used in reference to stream processing systems, means a collection of communicating processes, carrying out executions to collectively process streams of incoming data.

In this disclosure the term “module” means a group of one or more processes within a system, which is partitioned from other groups of processes within the system.

In this disclosure the term “DAG” means a directed acyclic graph consisting of a set of nodes and edges. As an example and not by way of limitation, in a graph G, an edge may be defined by an ordered pair (u,v) denoting that there is an edge connecting node u to node v for u, v in the set of nodes of G.

In this disclosure the term “DAG Workflow” has the same meaning as “stream processing” and is used for processing stream-based data which flows into the system from the sources (modules with no incoming edges) and out from the data sinks (modules with no outgoing edges). It refers to a collection of modules where the communication can be described by a DAG where the nodes are the modules and the edges correspond to the flow of communication in the workflow.

In this disclosure the term “module composition” means a technique whereby the output of one or more modules is directed to the input of another module.

In this disclosure the term “deadlock” means a type of error that occurs in message-passing programs where a communication cannot complete because of a circular set of dependencies on the completion of other communications. For example, deadlock can occur when not all processes in a collective operation call the operation at the same point in the program. In this case, while the other processes are communicating among themselves one or more processes are not and eventually the program stops, waiting for those processes which have not executed the collective operation.

In this disclosure the term “graph coloring” or “coloring” means the assignment of a unique integer (called its color) to each node in a graph such that for every edge in the graph the color assigned to the end of each edge is different. The graph represents an abstract model of the connections between different “nodes”, and the connections between the nodes are referred to as “edges”.

In this disclosure the term “graph labeling” mean labeling of the nodes or edges of a graph. In particular embodiments a graph labelling problem may arise when it is desired to label nodes and/or edges with integers such that the labeling satisfies special properties with respect to nodes and edges in the graph.

In this disclosure, the term “leader” means a process comprised in a module that is elected to be used as a leader process. The leader process can be used in the composition of modules to provide a simple composition technique whereby all communication between modules is coordinated via the leader process. In embodiments, compositions may be defined with respect to the group associated with the leader process or may be defined with respect to the group associated with the group of all processes in a module.

While some terms used herein may be generally thought of as representing aspects of an MPI system, they are used herein to include a full range of equivalent and related operations operable with other forms of system architecture and are not to be understood as limited to any particular architecture or environment.

Libraries as used in or in association with embodiments may include the following forms of library PICL [(ref picl)], PVM [(ref pvm91)], PARMACS [(ref parmacs)], p4 [(ref p4-manual)], Chameleon [(ref chameleon-user-ref)], Zipcode [(ref Skj92d)], and TCGMSG [(ref harrison:tcgmsg)]. In embodiments variants of such libraries or alternative library types may be utilised.

In embodiments, the methods disclosed may be implemented using a variety of hardware systems, which may include computers, computer systems, networks, and may comprise processes, systems, processors, computers or networks that are linked in parallel. In embodiments, suitable systems and programs may be or may comprise those available from IBM, HP, Dell and other cluster manufacturers.

### First Embodiment

In a first embodiment there is disclosed a computer implemented system for parallel processing which includes at least one process group which, during execution of the parallel process, includes: a first digital data stream generated by a first process; a second digital data stream generated by a second process; and, a third process for controllably receiving the first and second data streams and in response thereto generating a third digital data stream, wherein the first, second and third processes may have, be defined by, be associated with or be identified by a common unique communication context associated with said at least one group. In an alternative embodiment of the first embodiment there is disclosed a computer implemented method for parallel processing wherein the method may comprise: providing a process group which during execution of the parallel process, comprises: a first digital data stream generated by a first process; a second digital data stream generated by a second process; a third process for controllably receiving the first and second data streams and in response thereto generating a third digital data stream and defining the first, second and third processes by a common unique communication context associated with the at least one group.

In the first embodiment the systems disclosed make use of the following type of graph labeling that is constructed to provide a construction of communicators that is partly or wholly deadlock free.

Given a directed acyclic graph (G,E), the labeling of the directed edges of the graph is defined so that the label of edge eᵢ is a number from 1 to k. The labeling should have the following two properties:
1) the label of all incoming edges to a node must have the same label,
2) the label of all outgoing edges to a node must be distinct.

The technique used to construct this labeling is based on the coloring of a related graph which is called the conflict graph because it basically resolves any conflicts in previous edge labeling. The conflict graph is defined as follows:

Given a DAG G(V,E) the associated conflict graph C is the undirected graph with nodes V where there is edge between two nodes v, w in C whenever there exists a node u in V of G such that (u,v) and (u,w) are in E (i.e., the nodes share a common source).

In a first embodiment of the system, the system uses MPI. However, in embodiments a wide range of alternative interfaces, architectures and systems may be used, including but not limited to Dryad and P-RIO. In embodiments MPI may allow the library to be used on a variety of clusters, including the Grid with MPICH-G [11], and any open-source or proprietary workflow environment that can integrate with MPI.

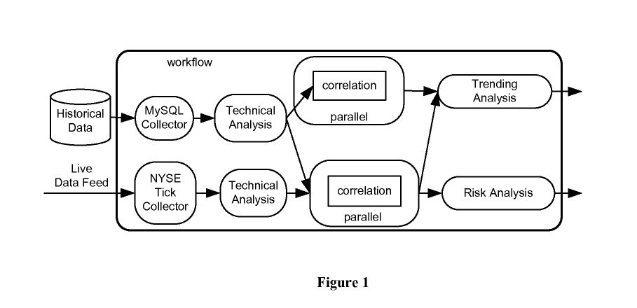

In an embodiment the underlying structure is a directed acyclic graph (DAG). FIG. 1 shows an example of a financial workflow comprised of a variety of modules connected together in a DAG.

In FIG. 1 there is a live data source and a database source that flow into the first two modules of the system, called the collector modules. The collector modules retrieve data for different assets (e.g., stock bid/ask quotes) and pass the data onto the technical analysis engines which create a stream of technical analysis indicators (e.g., price) based on each of the assets. The technical analysis engines pass the stream of data onto the correlation engines which periodically compute the correlation matrix using the time-series streams for all of the assets. The correlation components that do the bulk of the computation are themselves implemented in parallel using an arbitrary number of processes. The correlation engines pass the computed correlation matrices onto trend monitoring and risk analysis tools that use the correlation information for real-time measurement and forecasting of volatility and risk. The trending and risk analysis components are data sink modules and either pass the results outside the system for visualization, storage or input to an automated trading system. Each of the modules operates with respect to a time interval where data is pumped into the system, periodically triggering a computation, with computed results being passed onto the next component in the workflow.

The middleware used to implement workflows is MPI in the first embodiment, but a full range of other types of middleware may be used in alternative embodiments. Financial workflow systems like MarketMiner can take advantage of the large number of high quality numerical libraries that already use MPI. As a result, our library needed to ensure that it could integrate with and use existing MPI libraries and programs.

### A. Groups and Communicators

A communicator is an MPI object containing group information and a unique identifier called the context. In MPI, a group is a collection of processes where the processes in a group of size N are identified by their rank, an integer from 0 to N−1. The context is used to uniquely identify the group or groups for the communication. Group information and the context make it possible to guarantee that messages are matched by the intended communication routine. Essentially, communicators and groups provide a scoping mechanism for messages and can be used to structure the communication to support libraries, simplify programming and eliminate a common source of messaging errors.

There are two types of communicators: intra-communicators and inter-communicators. An intra-communicator is used to communicate inside a group and an inter-communicator is used to communicate between two groups. With respect to a given process, an inter-communicator contains information about the local group to which the process belongs, the remote group to which it can communicate, as well as the context. New communicators can only be created with respect to an outer enclosing communicator that contains all of the processes in the communicator.

MPI routines that create new communicators are collective operations with respect to the group associated with the outer communicator. A collective operation is one that requires communication between all of the members of the group and therefore the routine must be invoked by all members of the group at the same time. These requirements are necessary to ensure that a unique context identifier can be chosen for the communicator. Because creating communicators is a collective operation, care must be taken when groups are overlapping to avoid deadlock.

We take advantage of both inter and intra communicators inside our library. A module that is part of the workflow has its own intra-communicator that is the basis for all intra-module communication. Inter-communicators are used for inter-module communication where conceptually these inter-module connections are viewed as I/O ports with an agreed upon protocol specifying the type of data and manner of reading and writing the data to the port. Each component in the system has one or more inports and one or more outports. Ports can be many-to-one or one-to-many.

### Design of the Library

Our library consists of the following routines: workflow_Getenvironment( ), workflow_Init( ), workflow_Terminate( ), and various user defined workflow_Send( ) and workflow_Recv( ) routines. The following three sections describe the main parts of the library. Section IV-A describes workflow_Getenvironment( ) and initial set-up of the intra-communicators. Section IV-B describes the inter-communicators that are set-up by workflow_Init( ). Finally, Section IV-C describes the different types of protocol adapters and support for implementing custom user-defined ones.

### A. MPI Execution Environment

The mpiexec command can be used to start the execution of a MPI program. Users specify on the command line, or as a separate configuration file, the separate processes and number of processes of each type to start executing. Each separate process can have its own command line parameters.

We define three new command line parameters for every process: name, inports, and outports. Parameter name is a required parameter for every process. Parameters inports and outports are comma delimited strings from the same set of process names. The names are used to identify the set of all processes that belong to a module. The in-ports and out-ports specify the data flow connections between the modules. The resulting structure must be acyclic and all the processes belonging to the same module must have the same set of in-ports and out-ports (see FIG. 3).

Specifying the structure on the command line is a very simple and flexible technique for defining the workflow. The name parameter makes it possible for users to create modules consisting of one or more processes and it also makes it possible to use the same executable in different modules of the workflow. The workflow_Getenvironment( ) routine is used to retrieve the command line parameters and store the values into a environment variable that is an argument of workflow_Init( ). The one disadvantage to this approach is the potential for conflict with previously defined command line parameters for the process, which would require some modification to the program for the process. The functionality of workflow_Getenvironment( ) was separated from workflow_Init( ) to make it possible to extend the library with other techniques for obtaining the information needed to initialize the environment.

The workflow_Init( ) routine uses the list of names in the environment argument to create two new intra-communicators with respect to the outer communicator MPI_COMM_WORLD. MPI_COMM_WORLD is a predefined communicator that is associated with the group of all processes. We create an intra-communicator for all the processes in the same module. The intra-communicator acts as a localized MPI_COMM_WORLD, which simplifies porting stand-alone MPI programs into the workflow. We also select a leader from the processes within each module and create an intra-communicator for the group of all leaders. The leaders intra-communicator is used internally as the basis for the inter-module communication that is described later in Section VI.

The workflow_Init( ) routine uses the list of names in the environment argument to create two new intra-communicators. These intra-communicators are defined with respect to the outer communicator, called MPI_COMM_WORLD. MPI_COMM_WORLD is a predefined communicator that is associated with the group of all processes.

The first step in creating the two new communicators is to use the collective operation MPI_Allgather( ) to gather the names of all the processes. After execution, all processes will have a list of names where the index of the list is a mapping of process names to process ranks in MPI_COMM_WORLD. Each process uses the list to determine a module leader. If k is the index of the first occurrence of name A in the list, then process k is the leader for module A. All processes can now call
MPI_Comm_split(MPI_COMM_WORLD, myleader,0,&localcomm);
   which uses myleader as the key for partitioning MPI world and returning a new intra-communicator (localcomm) for each partition. Routine workflow_Init( ) will return localcomm to the calling process so that each module has its own intra-communicator. Similarly,
MPI_Comm_split(MPI_COMM_WORLD, key,0,&leadercomm);
   creates an intra-communicator for all leader processes by either setting key to one for leader processes and MPI_UNDEFINED otherwise. The leader intra-communicator is used internally as the basis for the inter module communicators that remain to be defined.

### B. Inter-Communicator Connections

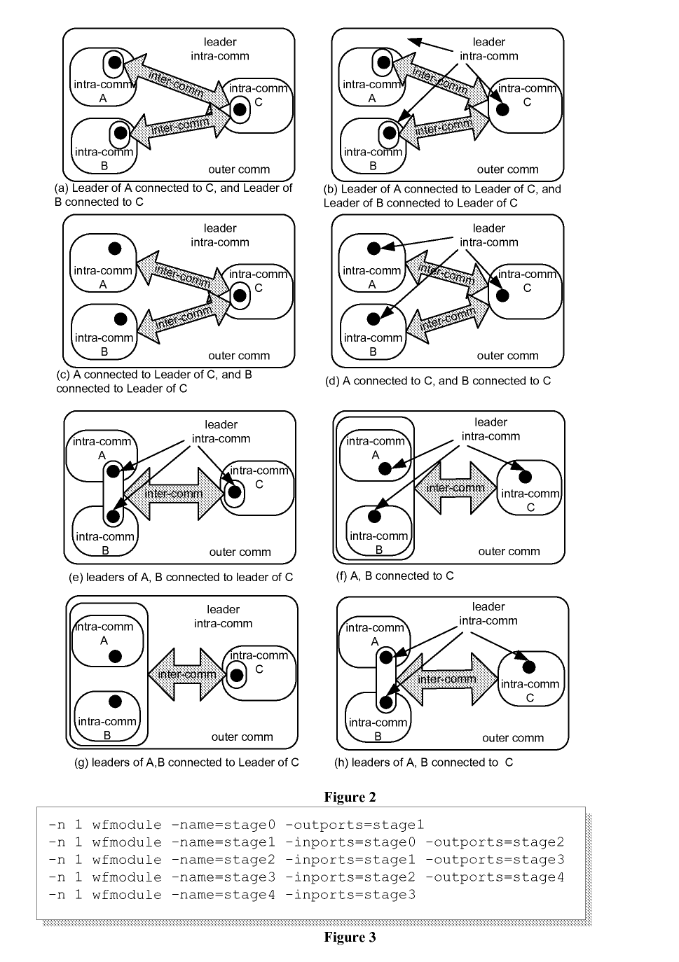

Consider the connection between modules in the workflow. As shown in FIG. 1 the out-ports of one or more modules are connected as in-ports of another module. There are various ways to use inter-communicators to connect the ports from the modules on the left to the module on right. FIG. 2 shows several different possibilities of how to connect two modules A and B with module C.

In FIG. 2, there can be any number of modules on the right side and the techniques are not limited to only A and B. The connections depicted in FIG. 2 are representative of the general type of connections and in general we can connect any combination of the following types of groups on the left:
1. MPI_COMM_SELF group for each leader (e.g., FIG. 1 (a)),
2. Subgroup (or entire group) of leaders (e.g., FIG. 1 (e)),
3. Subgroup (or entire group) of modules (or subset of processes in the module) (e.g., FIG. 1(g)).

The groups on the left can be connected to the following types of groups on the right:
1. MPI_COMM_SELF group of the leader (e.g., FIG. 1 (a,c,e,g)),
2. Module group (or subset of processes in the module) (e.g., FIG. 1 (b,d,f,h)).

Each of the configurations has its own advantages and disadvantages with regard to defining protocol adapters (section IV-C). In the case of (e), we combine the leaders of A and B into its own group and then create an inter-communicator between the A-B group and the MPI_COMM_SELF group of C's leader. This configuration is appropriate when each module uses the “root” process for I/O and the root is responsible for distributing and coalescing the data. The advantage of putting the leaders of A and B into the same group is that we can use MPI wildcards on the receive rather than looping over several inter-communicators. Case (h) is similar to (e), except now leaders coalesce the data but any process in group C can directly receive data from the leaders of A and B and avoid forwarding the data via the root. Case (f) is the most general where any member of A or B can forward data to any member of C A disadvantage of (f) is that because a new group was created to contain both A and B the rank of a process in the combined A-B group may not to be the same as the rank of the process in A or B. Case (d), unlike (f) where the ranks are with respect to the combined AB group, the ranks remain the same but will require looping over several inter-communicators. Configurations for using subgroups of the modules or subgroups of the leaders are possible using these techniques for specialized compositions of modules of a given type.

In general, although configuration (e) potentially introduces additional overhead for forwarding, in terms of encapsulation, modules can completely hide their internal communication structure. Routine workflow_Init( ) can configure either of these types, but all the modules of the workflow must use the same configuration strategy. The details of constructing type (e) configurations are given in Section VI. Construction of the configurations for the other types is very similar to (e).

Similar techniques can be used to with intra-communicators rather inter-communicators. These techniques also apply to the use of inter-communicators.

### C. Protocol Adapters

The final types of routines in the library are the inter-module communication routines. The two most simple types of routines to provide are workflow_Send( ) and workflow_Recv( )(see FIG. 5, lines 5 and 12). Users only need to specify the data, data type, and the local intra-communicator. The send routine sends the data on all of the out-ports and workflow_Recv( ) returns when it receives data on any of its in-ports.

These routines need access to the inter-communicators associated with the in-ports and out-port of the process. Rather than simply return the inter-communicators making them visible to the user, we use MPI attributes to attach the information to the local intra-communicator. MPI attributes implement a simple dictionary API that uses a unique key to bind data to a communicator. By adding the appropriate copy and deletion functions, communicators with the attached attributes act exactly like other communicators and can be duplicated, copied and deleted. In implementing the workflow versions of send/receive the workflow simply retrieves the appropriate inter-communicators and calls the MPI communication routine using the inter-communicators.

Although in general this works for simple structures, we also need to ensure that we use a protocol that matches the configuration of the inter-communicators. Thus, if we wish to receive from any of the in-ports then MPI_Recv( ) should use a wildcard to receive from MPI_ANY_SOURCE and MPI_Send( ) needs to loop over all of the out-port inter-communicators. We provide a simple set of protocol adapters mirroring the standard MPI_Send( ) and MPI_Recv( ) as well as specific ones for simple communication of integers and strings.

The library also provides routines for retrieving and testing inter-communicators. Other MPI routines can be used to query and determine the size and ranks of processes in the remote group. These routines allow users to implement their own customized routines that adapt the protocol to their particular application in cases when the standard communication routines are insufficient.

### V Example of a Simple Program

As a way of illustrating the use of the system we present a simple parallel pipeline implementing Eratosthenes' prime number sieve. The first module generates all odd numbers starting from two and each subsequent module keeps the first number it is given, which is a prime, and passes only those that do not divide by the number it keeps. The result is a output stream of numbers which are not multiples of the k primes in the preceding k modules.

FIG. 3 shows an MPICH configuration file for a pipeline of five modules all consisting of the same executable.

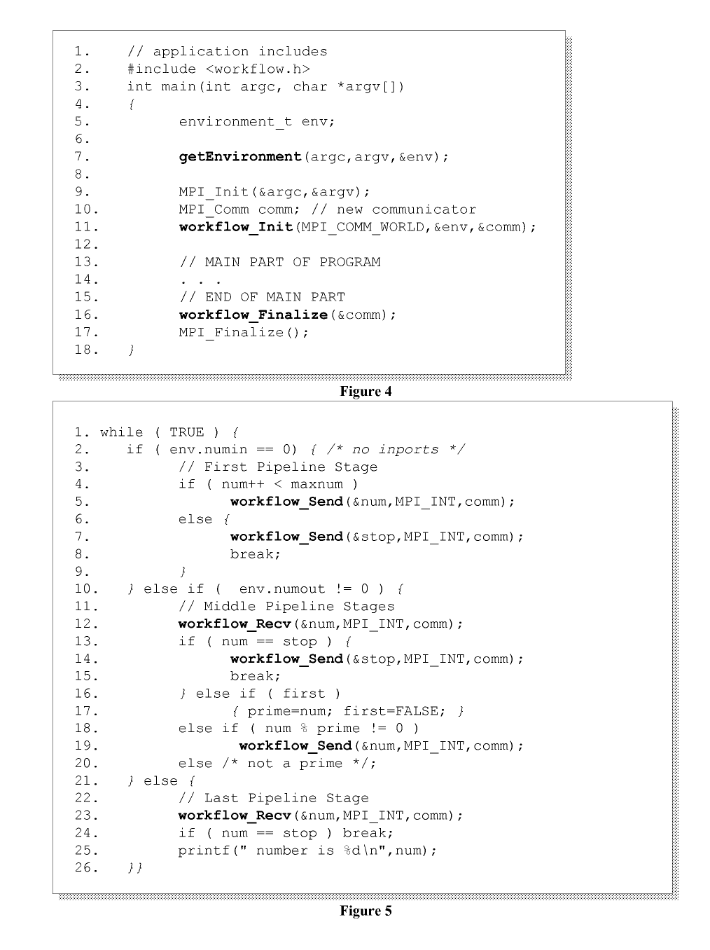

The single program called wfmodule is used for all the stages and consists of an MPI program with a few added routines. FIG. 4 shows the basic setup of the workflow. Routine getEnvironment( ) (line 7) obtains the list of input and output ports from the command line and stores them into the environment structure. The main work is done by workflow_Init( ) (line 11), which takes the communicator for the program and returns a replacement communicator that should now be used for all intra-module MPI communication. The rest of the program remains the same, except that where ever MPI_COMM_WORLD appears the new context should be used instead.

As FIG. 4 shows very few routines need to be added to a MPI program to make it into a workflow module. The final call to workflow_Finalize( )(line 16) frees all the resources attached to the new context. The main part of the program for the prime number sieve is shown in FIG. 5.

The first stage simply starts a flow of numbers (lines 3-9), the middle stages (lines 10-20) receive a number and forwards it when it is not divisible by prime and the last stage (lines 22-25) simply prints out the stream it receives. A special stop value is used to terminate the pipeline.

### VI Creating Communication Contexts

The routine workflow_Init( ) sets up the appropriate contexts within MPI. As mentioned, the objective of the routine is to create MPI inter-communicators between a set of modules on the “left” that send data to a module on the “right”. In the rest of the discussion we restrict the discussion to the inter-communicator structure between leader processes as shown in FIG. 2(a). This can be easily extended to the other three cases.

The basic MPI routine that is used to create the inter-communicators is:

MPI_Intercomm_create (MPI_Comm local_comm, int local_leader, MPI_Comm outer_comm, int remote_leader, int tag, MPI_Comm *comm_out).

MPI_Intercomm_create( ) is a collective operation with respect to local_comm. The routine uses message-passing in outer_comm between the leaders in both groups to create a unique context identifier for the inter-communicator, which is then distributed to the other members of the group. This operation can succeed only when all members of the groups on both sides of the communicator call the operation at the same time.

There is one additional distributed operation used to gather and distribute information between the nodes. In the next section we define a sweep operation, which takes advantage of the acyclic structure of the workflow to setup the necessary structures and parameters needed to create the inter-communicators.

### A. Sweep Operation

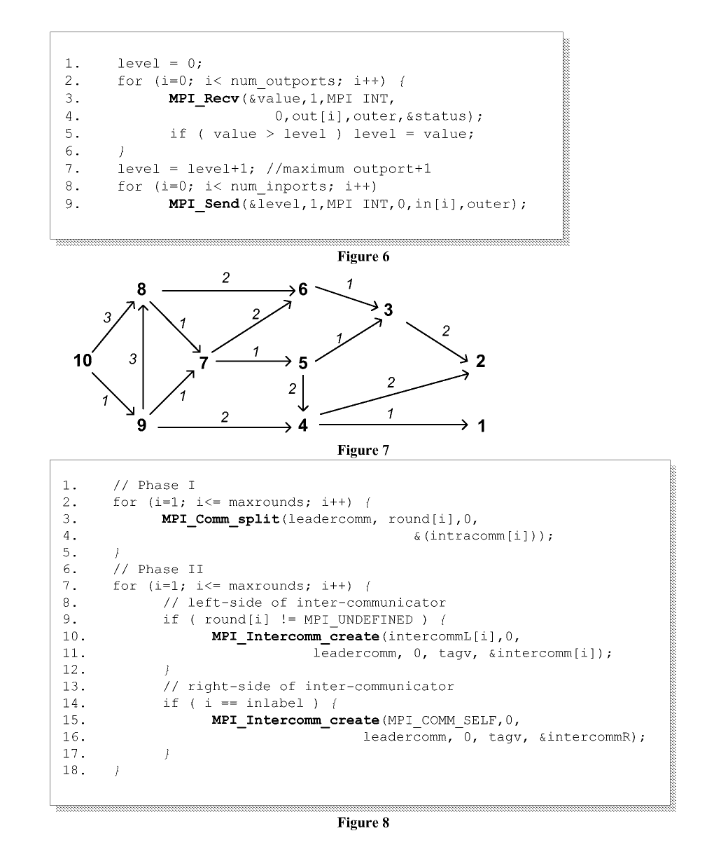

Given that the underlying workflow is acyclic, the program fragment shown in FIG. 6 can be used to make a single sweep of the nodes from sink to source.

In particular, the code fragment in FIG. 6 topologically sorts the workflow nodes starting from 0 for the data sinks (nodes with no out-ports). Lines 5 and 7 are specific to creating a topological ordering of the nodes and these instructions can be replaced to distribute other information in topological order. Similarly, by swapping the in-ports and out-ports at lines 2, 4 and 8, 9, we can sweep in the opposite direction. This simple operation is used for distributing or gathering information from a node's in-port or out-port neighbors. The execution time of the operation depends on the depth of workflow, the maximum distance from source to sink or vice versa.

### B. Inter and Intra Communicator Creation

The creation of intra and inter communicators needs more coordination because of the collective nature of the operations and the need to avoid deadlock.

Given a directed acyclic graph (G,E), i.e., a workflow, we define a labeling of the directed edges of the graph where the label of edge eᵢ is a number from 1 to k. The labeling must have the following two properties:
3) the label of all incoming edges to a node must have the same label,
4) the label of all outgoing edges to a node must be distinct.

If a labeling satisfies these two conditions, then the two phase algorithm to be described is deadlock free and constructs the inter and intra communicators as illustrated in FIG. 2(a). An example of a proper labeling of a directed acyclic graph is shown in FIG. 7.

Later in Section IV-C we give a coloring algorithm to create a proper labeling of any DAG.

The creation of the inter and intra communicators is performed in two separate phases. In Phase I, the intra-communicators among the leaders are created, and in Phase II we create the inter-communicators. Assume there is a properly labeled graph G among all of the leader nodes in the workflow. With respect to the labeling of G, before execution each leader process u has received the following information:
a) the maximum number of rounds (maxrounds), which is computed by the coloring algorithm in Section VI-C,
b) inlabel, the value of the incoming labels to node u, and
c) an array where round[i] is either MPI_UNDEFINED, when the node is not active in this round, or the rank of process v where edge (u,v) is labeled i.

The algorithm for constructing the communicators is shown in FIG. 8.

In Phase I (lines 2-5), all the necessary intra-communicators are created where intracomm[i] is an intra-communicator shared by the collection of processes whose out-ports point to the same process. As indicated in FIG. 2(a), these intra-communicators form the left-side of an inter-communicator with a single leader process on the right-side. In Phase II, the rounds are defined by the labeling so that the appropriate inter-communicator and leader process perform the left and right side parts on the same round thereby synchronizing with each other to create an inter-communicator.

The program is deadlock free because of the properties of the labeling. In Phase I, since all incoming edges (u,v) to process v have the same label (i.e., active on the same round) they will all execute MPI_Comm_split( ) at the same time. Since every outgoing edge has a different label, they do not conflict on a round. When there is no out-port with label i, then round[i] is MPI_UNDEFINED, which indicates that the node is not part of any intra-communicator on that round.

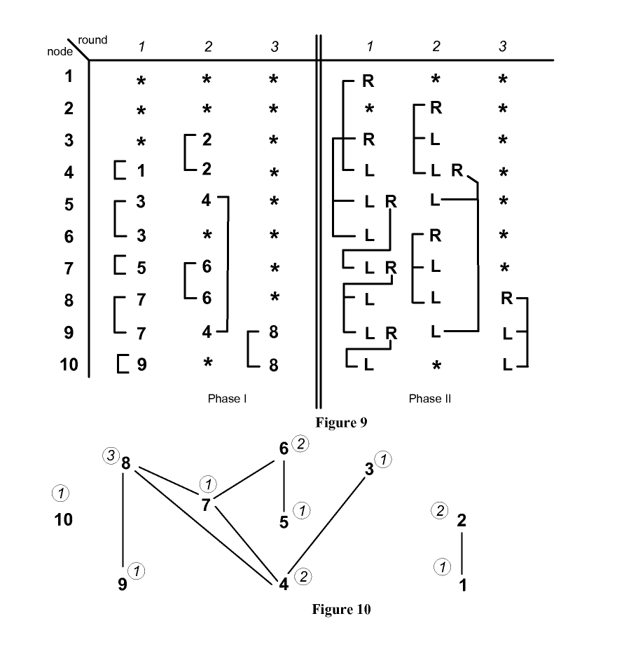

Using the DAG in FIG. 7 the creation of the intra-communicators is shown in FIG. 9 (Phase I).

The brackets in each column show the nodes which will become a member of a new intra-communicator on that round.

In Phase II we construct the inter-communicator from the right (FIG. 8, lines 15-16) and left (lines 10-11) intra-communicators. The labeling ensures that there is a matching between the nodes on the left side with those on the right side. As in Phase I the appropriate nodes are active at the same time. Since a incoming label can equal an outgoing label it is possible that a node must act as both the right and left side of MPI_Intercomm_create( ). In this case (FIG. 8, lines 9-16), we arrange for the collective communication to occur first on the left and then on the right. This ensures there is always at least one set of nodes that can complete the operation, thus eventually completing the round.

The brackets in Phase II of FIG. 9 show the role of the node in constructing the inter-communicator where “L” indicates that it is a member of the intra-communicator on the left and “R” indicates it is the intra-communicator for the right. If there are no in-ports to a node, then the node will never be on the right-hand side of MPI_Intercomm_create( ). A node is on the right in the round corresponding to the label of its in-ports.

At the end of these two phases we have the desired configuration of contexts to support arbitrary DAG communication. All the in-ports to a node are part of the same context which is connected via an inter-communicator to the node.

### Creating a Deadlock-Free Edge Labeling

The success of the previous parallel algorithm for creating the different contexts relies on the existence of a proper labeling of the DAG. We show that a proper labeling exists whenever there is coloring of an associated graph, which we call the conflict graph.

Given a DAG G(V,E) the associated conflict graph C is the undirected graph with nodes V where there is edge between two nodes v, w in C whenever there exists a node u in V of G such that (u,v) and (u,w) are in E (i.e., the nodes share a common source).

Given a coloring of C the label of the directed edge (u,v) in E of DAG G is simply the color of node v in C. The coloring conditions ensure there is a proper labeling of the DAG.

For example, FIG. 10 shows a coloring of the conflict graph associated with FIG. 7.

Using the previous rule, the graph in FIG. 10 can be used to construct the proper labeling shown in FIG. 7.

Graph coloring is NP-complete [17], however, there are good heuristics for this problem including distributed algorithms for computing a coloring in parallel [18]. Although a more sophisticated heuristic algorithm could be used, we currently use a simple algorithm based on the fact that every graph can be colored with at most maximum degree plus one colors. At most, this can result in |V| colors, leading to |V| rounds, or a sequential algorithm that linearly constructs the communicator structures one node at a time. The parallel algorithm consists of the following two phases.

Phase I: By swapping the in-ports and out-ports in FIG. 6 we can sweep through the DAG from the data sources (no in-ports) to the data sinks (no out-ports). Each node sends its out-port list to each of the nodes in the list. For example, in FIG. 7, node 9 sends (4, 7, 8) to nodes 4, 7 and 8. The union of the lists determines a node's adjacencies in the conflict graph. For example, node 7 receives (4, 7, 8) and (6, 7) implying that 7 is adjacent to 4, 6 and 8 in the conflict graph.

Phase II: In the second phase every node performs three actions with respect to the conflict graph. First, in MPI_COMM_WORLD or outer rank order, each node calls MPI_Recv( ) to obtain a color (integer from 1 to |V|) from all adjacent nodes of lesser rank. From the list of colors a node receives, the node chooses the smallest k not in the list. The node then calls MPI_Send( ) to send k to all nodes of greater rank. For example, in FIG. 10, node 7 first receives k=2 from node 4, then k=2 from node 6. The node chooses k=1, and then sends k=1 to node 8. Initially, nodes 1, 3, 5, 9 and 10 are all active and choose k=1.

There are two remaining actions to be performed. Every node needs to know the number of rounds, which is simply the maximum color used. The maximum color is obtained by a MPI_Allreduce( ) call on the outer context using the MAX operator where each node provides its chosen color as the parameter to the collective routine. Finally, every node must communicate the color it has chosen to every node in its list of in-ports, thus distributing the coloring to complete the edge labeling. All the data is available now to execute the algorithm in FIG. 8.

### D. Multi-Stage Pipelines

One special case of an acyclic structure that can be configured differently is a multi-stage pipeline. We define a multi-stage pipeline to be any DAG that is 2-colorable. If a DAG is 2-colorable, then the longest path from source to sink can be used to label the stages of the pipeline from 1 to K. FIG. 1 is an example of a 4 stage pipeline with 2 modules in each stage.

If the previous algorithm is used, then the conflict graph for a multi-stage pipeline consists of K components that can be independently colored. The two phases for constructing the intra and inter communicators are bounded by the maximum number of colors used in any of the components. Two collective calls are needed to construct each inter-communicator.

There is another technique that can be used in this case which results in fewer collective calls. By using the stage inside a single call to MPI_Comm_split( ) we can construct an intra-communicator for each stage. After which, the parity of the stages can be used to create inter-communicators between each pair of stages where odd stages are first on the left and then on the right (vice versa for the even stages) and appropriately omitting the ends. The stage inter-communicators can now be used in MPI_Comm_split( ) to create the new inter-communicators (see [19] for a discussion of creating inter-communicators in this way). MPI_Comm_split( ) is called first on the odd-even inter-communicator stages and then between the even-odd ones. For each stage inter-communicator we avoid conflicts on the left by peeling off one communicator at a time using each node on the right in turn. This technique does not reduce the overall number of steps but does eliminate some of the collective communication.

### VII Exemplary Operating Environments for Embodiments:

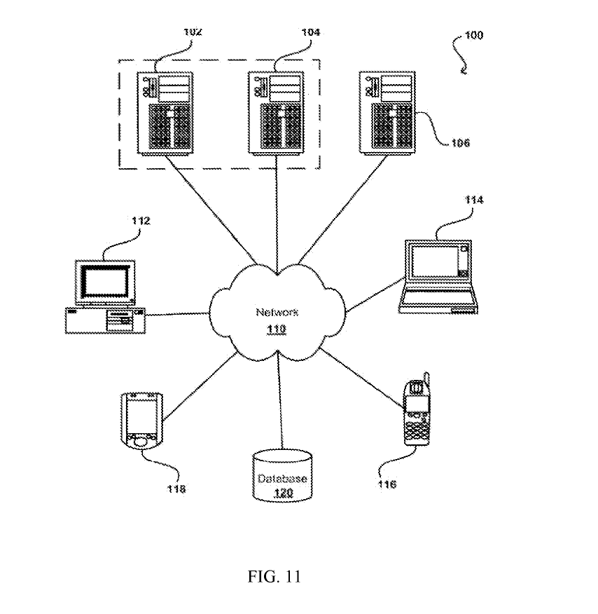

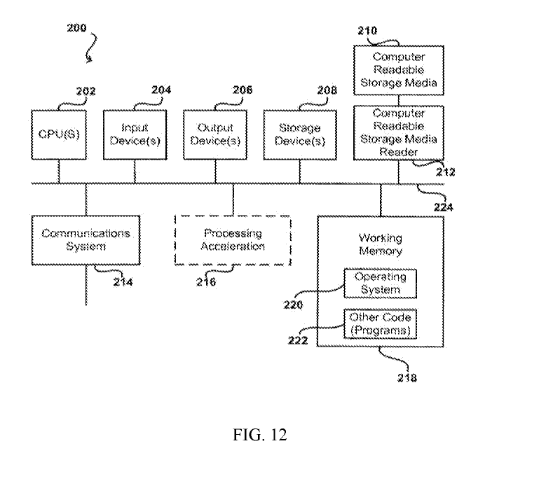

FIGS. 11 and 12 depict an exemplary operating environment for embodiments of the present disclosure.

FIG. 11 is a block diagram illustrating components of an exemplary operating environment in which various embodiments may be implemented. The system 100 can include one or more user computers, computing devices, or processing devices 112, 114, 116, 118, which can be used to operate a client, such as a dedicated application, web browser, etc. The user computers 112, 114, 116, 118 can be general purpose personal computers (including, merely by way of example, personal computers and/or laptop computers running a standard operating system), cell phones or PDAs (running mobile software and being Internet, e-mail, SMS, Blackberry, or other communication protocol enabled), and/or workstation computers running any of a variety of commercially-available UNIX or UNIX-like operating systems (including without limitation, the variety of GNU/Linux operating systems). These user computers 112, 114, 116, 118 may also have any of a variety of applications, including one or more development systems, database client and/or server applications, and Web browser applications. Alternatively, the user computers 112, 114, 116, 118 may be any other electronic device, such as a thin-client computer, Internet-enabled gaming system, and/or personal messaging device, capable of communicating via a network (e.g., the network 110 described below) and/or displaying and navigating Web pages or other types of electronic documents. Although the exemplary system 100 is shown with four user computers, any number of user computers may be supported.

In most embodiments, the system 100 includes some type of network 110. The network may can be any type of network familiar to those skilled in the art that can support data communications using any of a variety of commercially-available protocols, including without limitation TCP/IP, SNA, IPX, AppleTalk, and the like. Merely by way of example, the network 110 can be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, GRPS, GSM, TIMTS, EDGE, 2G, 2.5G, 3G, 4G, Wimax, WiFi, CDMA 2000, WCDMA, the Bluetooth protocol known in the art, and/or any other wireless protocol); and/or any combination of these and/or other networks.

The system may also include one or more server computers 102, 104, 106 which can be general purpose computers, specialized server computers (including, merely by way of example, PC servers, UNIX servers, mid-range servers, mainframe computers rack-mounted servers, etc.), server farms, server clusters, or any other appropriate arrangement and/or combination. One or more of the servers (e.g., 106) may be dedicated to running applications, such as a business application, a Web server, application server, etc. Such servers may be used to process requests from user computers 112, 114, 116, 118. The applications can also include any number of applications for controlling access to resources of the servers 102, 104, 106.

The Web server can be running an operating system including any of those discussed above, as well as any commercially-available server operating systems. The Web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 112, 114, 116, 118. As one example, a server may execute one or more Web applications. The Web application may be implemented as one or more scripts or programs written in any programming language, such as Java®, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 112, 114, 116, 118.

The system 100 may also include one or more databases 120. The database(s) 120 may reside in a variety of locations. By way of example, a database 120 may reside on a storage medium local to (and/or resident in) one or more of the computers 102, 104, 106, 112, 114, 116, 118. Alternatively, it may be remote from any or all of the computers 102, 104, 106, 112, 114, 116, 118, and/or in communication (e.g., via the network 110) with one or more of these. In a particular set of embodiments, the database 120 may reside in a storage-area network (“SAN”) familiar to those skilled in the art. Similarly, any necessary files for performing the functions attributed to the computers 102, 104, 106, 112, 114, 116, 118 may be stored locally on the respective computer and/or remotely, as appropriate. In one set of embodiments, the database 120 may be a relational database, such as Oracle IOg, that is adapted to store, update, and retrieve data in response to SQL-formatted commands.

FIG. 12 illustrates an exemplary computer system 200, in which various embodiments may be implemented. The system 200 may be used to implement any of the computer systems described above. The computer system 200 is shown comprising hardware elements that may be electrically coupled via a bus 224. The hardware elements may include one or more central processing units (CPUs) 202, one or more input devices 204 (e.g., a mouse, a keyboard, etc.), and one or more output devices 206 (e.g., a display device, a printer, etc.). The computer system 200 may also include one or more storage devices 208. By way of example, the storage device(s) 208 can include devices such as disk drives, optical storage devices, solid-state storage device such as a random access memory (“RAM”) and/or a read-only memory (“ROM”), which can be programmable, flash-updateable and/or the like.

The computer system 200 may additionally include a computer-readable storage media reader 212, a communications system 214 (e.g., a modem, a network card (wireless or wired), an infra-red communication device, etc.), and working memory 218, which may include RAM and ROM devices as described above. In some embodiments, the computer system 200 may also include a processing acceleration unit 216, which can include a digital signal processor DSP, a special-purpose processor, and/or the like.

The computer-readable storage media reader 212 can further be connected to a computer-readable storage medium 210, together (and, optionally, in combination with storage device(s) 208) comprehensively representing remote, local, fixed, and/or removable storage devices plus storage media for temporarily and/or more permanently containing, storing, transmitting, and retrieving computer-readable information. The communications system 214 may permit data to be exchanged with the network and/or any other computer described above with respect to the system 200.

The computer system 200 may also comprise software elements, shown as being currently located within a working memory 218, including an operating system 220 and/or other code 222, such as an application program (which may be a client application, Web browser, mid-tier application, RDBMS, etc.). It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, data signals, data transmissions, or any other medium which can be used to store or transmit the desired information and which can be accessed by the computer. Based on the disclosure and teachings provided herein, a person of ordinary skill in the art will appreciate other ways and/or methods to implement the various embodiments.

### Alternative Embodiments

In alternative embodiments of the systems and methods of embodiments, the system may be represented by a conflict graph wherein each node in the graph is tagged to avoid deadlock in the system.

In alternative embodiments of the systems and methods of embodiments, the system may further comprise a plurality of the process groups, each group having a communication context distinct from the other groups.

In alternative embodiments of the systems and methods of embodiments, the system may further comprising a plurality of the first processes each having an associated first context, and wherein said third process uses a said first context to distinguish between individual ones of said first processes.

In alternative embodiments of the systems and methods of embodiments, the system may further comprise a display for displaying the third data stream in real time.

In alternative embodiments of the systems and methods of embodiments, the first and second processes may be performed periodically and the periods may be less than about five minutes, four minutes, three minutes, two minutes, one minute, thirty seconds, twenty seconds, or less than about ten seconds.

In alternative embodiments the context may be generated probabilistically.

In alternative embodiments each process may comprise or be associated with a leader and the context information may be associated with the leader.

### Embodiments and Examples not Limiting

The embodiments and examples presented herein are illustrative of the general nature of the subject matter claimed and are not limiting. It will be understood by those skilled in the art how these embodiments can be readily modified and/or adapted for various applications and in various ways without departing from the spirit and scope of the subject matter disclosed claimed. The claims hereof are to be understood to include without limitation all alternative embodiments and equivalents of the subject matter hereof. Phrases, words and terms employed herein are illustrative and are not limiting. Where permissible by law, all references cited herein are incorporated by reference in their entirety. It will be appreciated that any aspects of the different embodiments disclosed herein may be combined in a range of possible alternative embodiments, and alternative combinations of features, all of which varied combinations of features are to be understood to form a part of the subject matter claimed.

The embodiments of the invention in which an exclusive property or privilege is claimed are defined as follows:

1. A computer implemented system for parallel processing which includes at least one process group which, during execution of the parallel process, includes:
(a) a first digital data stream generated by a first process;
(b) a second digital data stream generated by a second process; and,
(c) a third process for controllably receiving said first and second data streams and in response thereto generating a third digital data stream,
wherein said first, second and third processes are defined by a common unique communication context associated with said at least one group.

2. The system according to claim 1, wherein the system can be represented by a conflict graph wherein each node in said graph is tagged to avoid deadlock in the system.

3. The system according to claim 1, further comprising a plurality of said process groups, each group having a communication context distinct from the other groups.

4. The system according to claim 1, further comprising a plurality of said first processes each having an associated first context, and wherein said third process uses a said first context to distinguish between individual ones of said first processes.

5. The system according to claim 1, wherein said system comprises a display for displaying said third data stream in real time.

6. The system according to claim 1, wherein said first and second processes are performed periodically.

7. The system according to claim 6 wherein said periods are less thirty seconds.

8. The system according to claim 1 wherein said context is generated probabilistically.

9. A computer implemented method for parallel processing wherein the method comprises:
providing a process group which during execution of the parallel process, comprises:
(a) a first digital data stream generated by a first process;
(b) a second digital data stream generated by a second process;
(c) a third process for controllably receiving said first and second data streams and in response thereto generating a third digital data stream
and defining said first, second and third processes by a common unique communication context associated with said at least one group.

10. The method according to claim 9, wherein the system can be represented by a conflict graph wherein each node in said graph is tagged to avoid deadlock in the system.

11. The method according to claim 9, further comprising providing a plurality of said process groups, each group having a communication context distinct from the other groups.

12. The method according to claim 9, further comprising providing a plurality of said first processes each having an associated first context, and wherein said third process uses a said first context to distinguish between individual ones of said first processes.

13. The method according to claim 9, wherein said system comprises a display for displaying said third data stream in real time.

14. The method according to claim 9, wherein said first and second processes are performed periodically.

15. The method according to claim 14 wherein said periods are less thirty seconds.

16. The method according to claim 9 wherein said context is generated probabilistically.
